(19) United States
(12) Patent Application Publication
(10) Pub. No.: US 2007/0045242 A1
(43) Pub. Date: Mar. 1, 2007

(54) Plasma processing apparatus and processing method, and flat panel display manufacturing method

(75) Inventors: Naohisa Goto, Hachioji-shi (JP); Tadahiro Ohmi, Sendai-shi (JP); Tamotsu Morimoto, Nirasaki-shi (JP)

Correspondence Address: CROWELL & MORING LLP;INTELLECTUAL PROPERTY GROUP, P.O. BOX 14300, WASHINGTON, DC, 20044-4300, US

(73) Assignees: Naohisa Goto, Hachioji-shi (JP); TOHOKU UNIVERSITY, Sendai-shi (JP); TOKYO ELECTRON LIMITED, Minato-ku (JP)

(21) Appl. No.: 11/210,851

(22) Filed: Aug. 25, 2005

(51) Int. Cl. B23K 9/00; B23K 9/02

(52) U.S. Cl. 219/121.43

(57) ABSTRACT

A plasma processing apparatus includes a stage, processing vessel, and microwave supply device. A target object is placed on the stage. The processing vessel accommodates the stage. The microwave supply device supplies microwaves into the processing vessel, and includes a parallel-plate waveguide, a plurality of slots, a square waveguide array, and a distributor. The parallel-plate waveguide includes a first conductive plate which is rectangular when seen from the top and arranged to oppose the stage, and a second conductive plate which is arranged substantially parallel to the first conductive plate and has the same shape as that of the first conductive plate when seen from the top. The plurality of slots are formed in the first conductive plate. The square waveguide array includes a plurality of square waveguides aligned in their widthwise directions (X) perpendicular to there axial directions (Y). One end of each of the square waveguides is connected to the parallel-plate waveguide. The distributor is connected to the other end of each of the square waveguides and distributes and supplies the microwaves to the square waveguides with the same phase. A plasma processing method and a flat panel display manufacturing method are also disclosed.

### BACKGROUND OF THE INVENTION

The present invention relates to a plasma processing apparatus and processing method and, more particularly, to a plasma processing apparatus and processing method for processing a target object such as a flat panel display using a plasma generated by microwaves.

In the manufacture of a flat panel display such as an LCD (liquid crystal display), plasma processing apparatuses are widely used to perform processes such as etching, ashing, and CVD (Chemical Vapor Deposition). Among the plasma processing apparatuses, a microwave plasma processing apparatus is available which supplies microwaves into a processing vessel to ionize or excite a gas in the processing vessel, thus generating a plasma. As the microwave plasma processing apparatus, one which uses a plane antenna, e.g., a radial line slot antenna, having a circular radiation surface as a microwave supply means has been put into practical use. Currently, a microwave plasma processing apparatus which uses a plane antenna having a square radiation surface is under development. An example of such a microwave plasma processing apparatus includes one which uses an antenna array including a plurality of waveguide slot antennas.

A conventional plasma processing apparatus which uses a waveguide slot antenna is disclosed in, e.g., Japanese Patent Laid-Open No. 11-111493. As shown in FIG. 11, this plasma processing apparatus has a stage 902 where an LCD substrate 903 or the like is to be placed as a target object, a bottomed cylindrical processing vessel 901 which is square when seen from the top and accommodates the stage 902, exhaust ports 906 for vacuum evacuation which are formed in the peripheral portion of the bottom surface of the processing vessel 901, a gas introduction port 907 which introduces a gas into the processing vessel 901, a dielectric plate 908 which closes the upper opening of the processing vessel 901, and a waveguide slot antenna array 970 which is disposed above the dielectric plate 908.

As shown in FIG. 12, the waveguide slot antenna array 970 includes a plurality of waveguide slot antennas 970A, 970B, 970C, and 970D. Each of the waveguide slot antennas 970A to 970D is an antenna obtained by forming a plurality of radiation slots 921 in an H-surface (a larger side wall parallel to the magnetic field) of a radiation waveguide formed of a square waveguide. One end of the radiation waveguide is open while the other end is short-circuited. The radiation slots 921 are formed in the axial direction of the radiation waveguide at a predetermined interval based on the tube waveguide. Such waveguide slot antennas 970A to 970D are aligned in their widthwise directions perpendicular to the axial direction of the radiation waveguides such that the H-surfaces of the radiation waveguides having the radiation slots 921 oppose the stage 902.

A microwave distributor 980 is connected to the leading portion of the waveguide slot antenna array 970. The microwave distributor 980 has a leading portion 981 to which a microwave oscillator 942 is connected through a microwave waveguide 941, a branching portion 982 which branches into two from the distal end of the leading portion 981 to respectively extend in oblique directions, a parallel portion 983 which extends parallel to the axial directions of the radiation waveguides of the waveguide slot antennas 970A to 970D from the branched distal ends of the branching portion 982, and a dividing portion 984 which has the same width as the sum of the widths of the radiation waveguides of the waveguide slot antennas 970A to 970D. A stub 985 is provided to the center of the boundary of the leading portion 981 and branching portion 982. The dividing portion 984 is partitioned at the center in its widthwise direction by a partition plate 986 extending in the axial directions of the radiation waveguides.

In the plasma processing apparatus with the above structure, when the microwave oscillator 942 is driven, microwaves are introduced to the leading portion 981 of the microwave distributor 980 through the microwave waveguide 941. The microwaves introduced to the leading portion 981 are phase-adjusted by the stub 985, are divided into two by the branching portion 982, and reach the dividing portion 984 through the parallel portion 983, so that the microwaves are introduced to the respective radiation waveguides of the waveguide slot antennas 970A to 970D. The microwaves introduced to the radiation waveguides are gradually radiated from the plurality radiation slots 921 formed in the H-surfaces while they propagate in the tubes, and supplied into the processing vessel 901 through the dielectric plate 908. The electric field of the microwaves supplied into the processing vessel 901 accelerates electrons to ionize, excite, and dissociate the gas in the processing vessel 901, thus generating a reaction-active species. The reaction-active species processes the surface of the LCD substrate 903 on the stage 902 by, e.g., etching.

As in this plasma processing apparatus, when the antenna array 970 including the plurality of waveguide slot antennas 970A to 970D is used, the microwaves can be supplied to a wide range in the processing vessel 901, which is square when seen from the top, to generate a plasma. As the microwave distributor 980 is symmetric with respect to a center line C parallel to the axial directions of the radiation waveguides of the waveguide slot antennas 970A to 970D, it can also distribute the microwaves from the microwave oscillator 942 to the plurality of waveguide slot antennas 970A to 970D with the same phase and same power.

The closer to the radiation slots 921 through which the microwaves are supplied, the higher the field strength in the processing vessel 901. The higher the field strength, the more plasma generation is promoted. Thus, the plasma density distribution in the processing vessel 901 tends to be high in the vicinities of the radiation slots 921. To further uniform the plasma density distribution, the tube wavelengths of the radiation waveguides of the waveguide slot antennas 970A to 970D may be decreased, and the interval of the radiation slots 921 arranged in the axial directions of the radiation waveguides may be decreased accordingly.

The tube wavelength in the waveguide is inversely proportional to the square root of the relative dielectric constant in the waveguide. Accordingly, to decrease the tube wavelength in the radiation waveguide, a delay member made of a dielectric having a relative dielectric constant larger than 1 may be arranged in the tube.

When delay members are to be arranged in the tubes of the radiation waveguides, delay members which match the sizes of the radiation waveguides must be formed to correspond in number to the waveguide slot antennas 970A to 970D and must be inserted in the tubes of the respective radiation waveguides. This increases the manufacturing cost of the plasma processing apparatus.

### SUMMARY OF THE INVENTION

The present invention has been made to solve this problem, and has as its object to suppress an increase in manufacturing cost of a plasma processing apparatus which occurs when the plasma density distribution is uniformed.

In order to achieve the above object, according to the present invention, there is provided a plasma processing apparatus comprising a stage which places a target object thereon, a processing vessel which accommodates the stage, and a microwave supply device which supplies microwaves into the processing vessel, the microwave supply device including a parallel-plate waveguide including a first conductive plate which is rectangular when seen from the top and arranged to oppose the stage and a second conductive plate which is arranged substantially parallel to the first conductive plate and has the same shape as that of the first conductive plate when seen from the top, a plurality of slots formed in the first conductive plate, a square waveguide array which includes a plurality of square waveguides aligned in widthwise directions (X) thereof perpendicular to axial directions (Y) thereof and in which one end of each of the square waveguides is connected to the parallel-plate waveguide, and a distributor which is connected to the other end of each of the square waveguides and distributes and supplies the microwaves to the square waveguides with the same phase.

According to the present invention, there is also provided a plasma processing method comprising the steps of supplying in-phase microwaves to a plurality of square waveguides which form a square waveguide array, introducing the microwaves transmitted through the square waveguides to a parallel-plate waveguide having a plurality of slots, supplying the microwaves propagating in the parallel-plate waveguide into the processing vessel through the slots, generating a plasma using the microwaves supplied into the processing vessel, and processing a target object on a stage accommodated in the processing vessel using the generated plasma.

According to the present invention, there is also provided a flat panel display manufacturing method comprising the steps of supplying in-phase microwaves to a plurality of square waveguides which form a square waveguide array, introducing the microwaves transmitted through the square waveguides to a parallel-plate waveguide having a plurality of slots, supplying the microwaves propagating in the parallel-plate waveguide into the processing vessel through the slots, generating a plasma using the microwaves supplied into the processing vessel, and processing a target object on a stage accommodated in the processing vessel using the generated plasma in accordance with any one of etching, ashing, and CVD.

### BRIEF DESCRIPTION OF THE DRAWINGS

FIG. 1 is a longitudinal sectional view showing the overall structure of a plasma processing apparatus according to the first embodiment of the present invention;

FIG. 2 is a cross-sectional view of the structure of a microwave supply device which is used in the plasma processing apparatus shown in FIG. 1;

FIG. 3 is an exploded perspective view of the structure of an antenna unit which is included in the microwave supply device;

FIG. 4 is a cross-sectional view conceptually showing propagation of microwaves in the microwave supply device;

FIG. 5 is a cross-sectional view showing an arrangement of radiation slots;

FIG. 6 is a cross-sectional view showing the structure of a microwave supply device which is used in a plasma processing apparatus according to the second embodiment of the present invention;

FIG. 7 is a longitudinal sectional view taken in the direction of the line VII-VII′ of FIG. 6;

FIG. 8 is a view showing an arrangement of a plasma processing apparatus according to the third embodiment of the present invention in a case wherein a plurality of microwave supply devices are used in combination;

FIG. 9 is a view showing another arrangement of the plasma processing apparatus according to the third embodiment of the present invention in a case wherein a plurality of microwave supply devices are used in combination;

FIG. 10 is a longitudinal sectional view taken in the direction of the line X-X′ of FIG. 9;

FIG. 11 is a longitudinal sectional view showing the overall structure of a conventional plasma processing apparatus which uses a waveguide slot antenna array; and

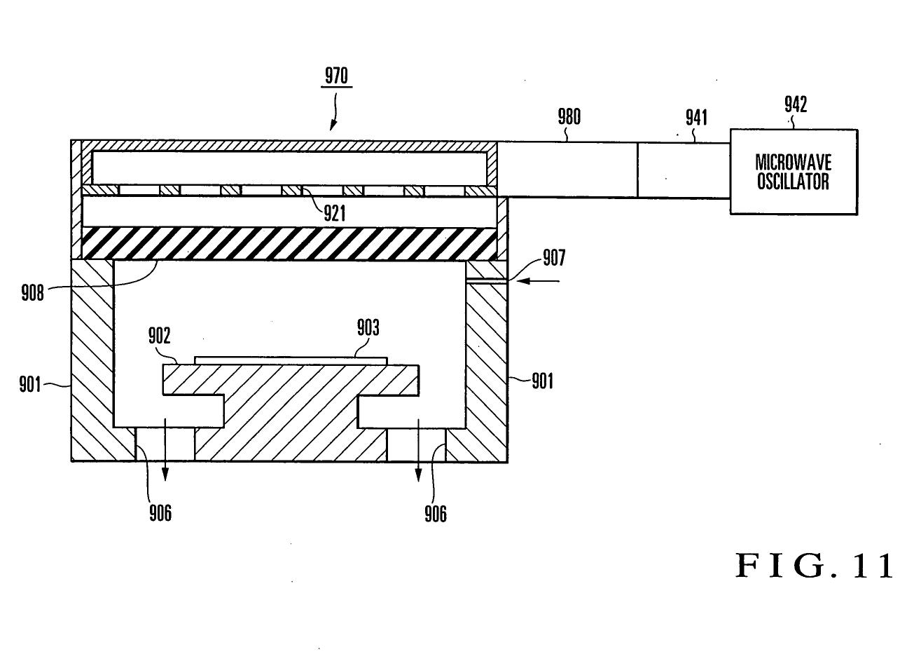

FIG. 12 is a cross-sectional view of the arrangement of part of the conventional plasma processing apparatus which includes the waveguide slot antenna array.

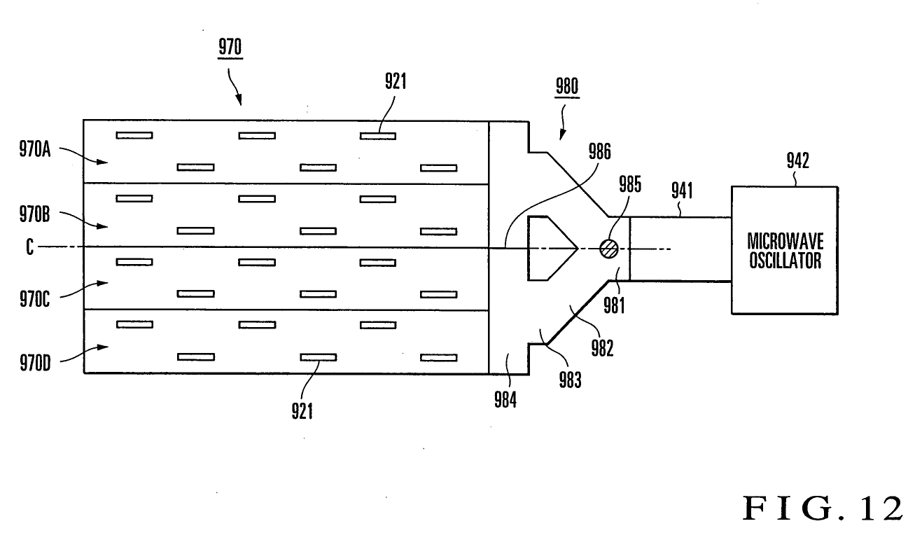

### DESCRIPTION OF THE PREFERRED EMBODIMENTS

The preferred embodiments of the present invention will be described in detail with reference to the accompanying drawings.

### First Embodiment

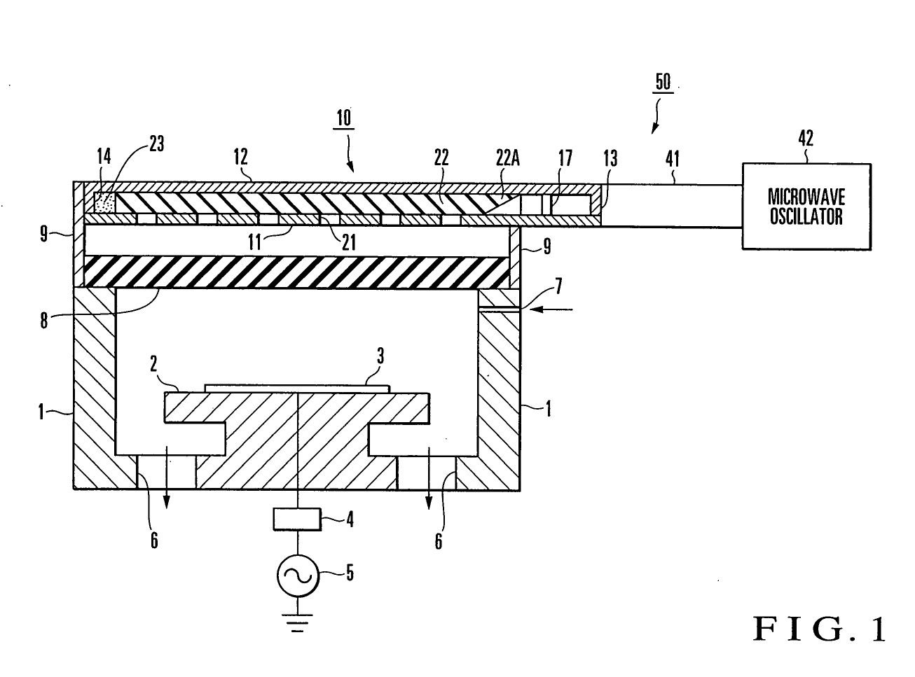

As shown in FIG. 1, a plasma processing apparatus according to the first embodiment of the present invention has a bottomed cylindrical processing vessel 1 which is square when seen from the top. The processing vessel 1 is made of a metal such as Al. A stage 2 is disposed at the central portion of the bottom surface of the processing vessel 1. An LCD substrate 3 or the like is arranged as a target object on the upper surface of the stage 2. The stage 2 is connected to a high-frequency power supply 5 through a matching box 4.

Exhaust ports 6 for vacuum evacuation are formed in the peripheral portion of the bottom surface of the processing vessel 1. A gas introduction port 7 through which a gas is introduced is formed in the side wall of the processing vessel 1. When the plasma processing apparatus is to be used as an etching apparatus, a plasma gas such as Ar and a reaction gas such as CF₄ are introduced.

The upper opening of the processing vessel 1 is closed with a dielectric plate 8 made of silica glass or the like, so a plasma generated in the processing vessel 1 will not leak outside while microwaves are being introduced through the upper opening. An O-ring is interposed between the upper surface of the side wall of the processing vessel 1 and the dielectric plate 8 to ensure hermeticity in the processing vessel 1.

An antenna unit 10 is disposed above the dielectric plate 8. The outer surfaces of the dielectric plate 8 and antenna unit 10 are covered with a shield material 9 which is annularly disposed on the side wall of the processing vessel 1. The antenna unit 10, a microwave waveguide 41, and a microwave oscillator 42 constitute a microwave supply device 50. The microwave supply device 50 externally supplies microwaves into the processing vessel 1 through the dielectric plate 8. As the outer surfaces of the dielectric plate 8 and antenna unit 10 are covered with the shield material 9, the microwaves supplied into the processing vessel 1 are prevented from leaking outside.

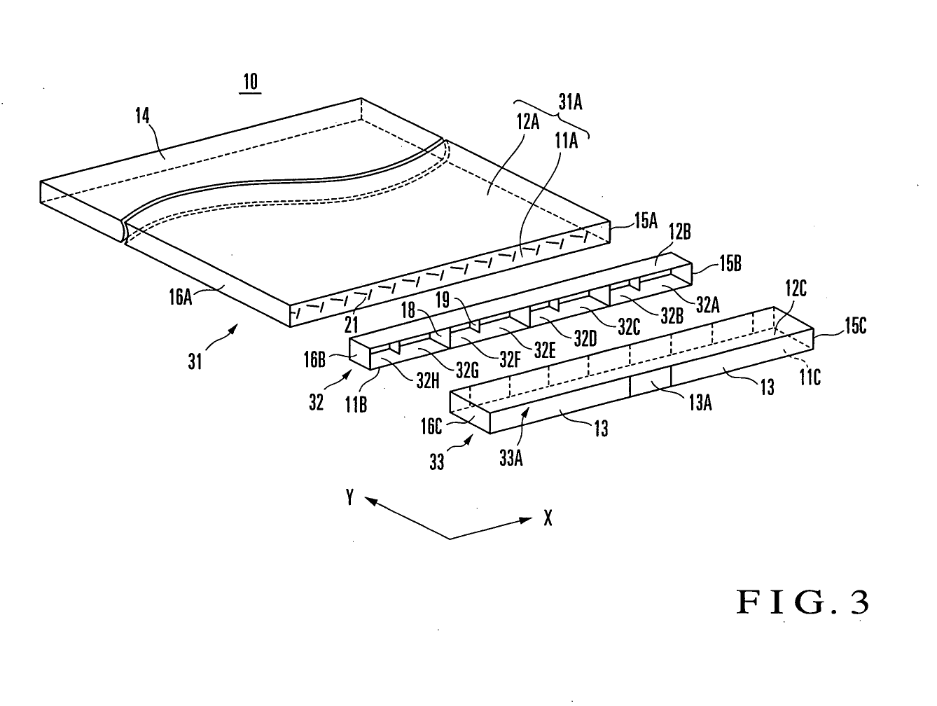

As shown in FIG. 3, the antenna unit 10 includes a parallel-plate waveguide slot antenna (to be abbreviated as a parallel-plate antenna hereinafter) 31, square waveguide array 32, and microwave distributor 33.

The parallel-plate antenna 31 is an antenna obtained by forming slots in one of two flat plates that form a parallel-plate waveguide 31A. In this embodiment, the parallel-plate waveguide 31A includes a first conductive plate 11A which is square when seen from the top and arranged to oppose the stage 2, a second conductive plate 12A which is arranged substantially parallel to the first conductive plate 11A and has the same shape as that of the first conductive plate 11A when seen from the top, and side walls 14, 15A, and 16A formed of conductors which connect the three sides of the first conductive plate 11A and the three sides of the second conductive plate 12A. That end face of the parallel-plate waveguide 31A which opposes the side wall 14 is open. This end face will be called an opening. While the conductive plates 11A and 12A form a parallel-plate, they need not be completely parallel to each other. One of the conductive plates 11A and 12A may be slightly inclined with respect to the other. Also, at least one of the conductive plates 11A and 12A may be slightly arcuate.

As shown in FIG. 1, a delay member 22 made of a dielectric is arranged in the parallel-plate waveguide 31A. A wavelength λg obtained when the delay member 22 is arranged is:
λg=λg₀/(εr)^{1/2} (1)
where εr (>1) is the relative dielectric constant of the delay member 22 and λg₀ is the tube wavelength when the interior of the parallel-plate waveguide 31A is hollow. The opening-side end of the delay member 22 forms an inclination 22A so the thickness of the delay member 22 changes gradually.

A microwave absorbing member 23 is arranged at that terminal end of the interior of the parallel-plate waveguide 31A which opposes the opening. The terminal end is short-circuited by the side wall 14 and accordingly the microwave absorbing member 23 is not always necessary.

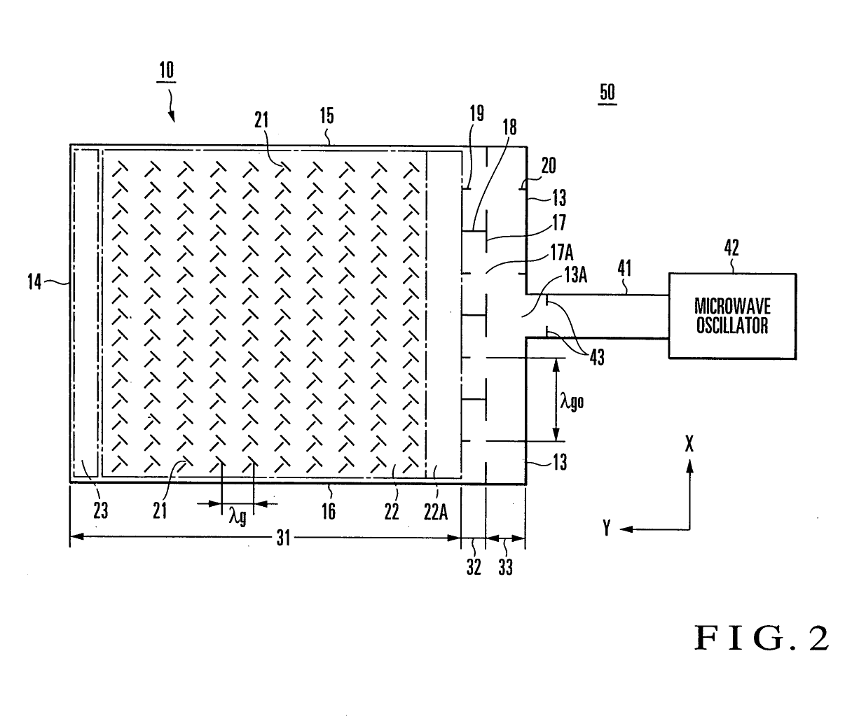

As shown in FIG. 2, the first conductive plate 11A which opposes the stage 2 has a plurality of radiation slots 21. As the radiation slots 21, inverted-V shaped slots which radiate circularly polarized waves are used. In each inverted-V shaped slot, the extension line of one slot crosses the other slot or its extension line. Each inverted-V shaped slot is arranged such that the electric fields radiated from the respective slots have the same magnitude and are phase-shifted from each other by 90°, and that their polarizing directions are orthogonal. For the sake of descriptive convenience, assume that X- and Y-axes are set to be respectively parallel to the side walls 14 and 15A. In the Y-axis direction as the traveling direction of the microwaves, the radiation slots 21 are arranged at an interval of substantially a natural number multiple of λg. In the X-axis direction, the radiation slots 21 may be arranged thick to such a degree that the adjacent radiation slots 21 will not overlap.

As shown in FIG. 3, in the square waveguide array 32, a plurality of square waveguides 32A, 32B, 32C, 32D, 32E, 32F, 32G, and 32H are aligned in their widthwise directions (X-axis direction) perpendicular to their axial directions (Y-axis direction). The square waveguide array 32 and parallel-plate waveguide 31A have the same length in the X-axis direction. Namely, the sum of the widths of the square waveguides 32A to 32H is equal to the length in the X-axis direction of the side wall 14 of the parallel-plate waveguide 31A. Each of the square waveguides 32A to 32H has two open ends, one end of which is connected to the opening of the parallel-plate waveguide 31A.

The microwave distributor 33 is obtained by forming a plurality of feeding windows 17A in an E-surface (a smaller side wall parallel to the electric field) 17 of a feeding waveguide 33A formed of a square waveguide. The microwave distributor 33 and square waveguide array 32 have the same length in the X-axis direction. Namely, the length in the X-axis direction of the feeding waveguide 33A is equal to the sum of the widths of the square waveguides 32A to 32H.

As shown in FIG. 2, the feeding waveguide 33A has an opening 13A at the central portion of an E-surface 13 which opposes the E-surface 17 where the feeding windows 17A are formed. The opening 13A is connected to the microwave oscillator 42, having an oscillation frequency of, e.g., 2.45 GHz, through the microwave waveguide 41 formed of a square waveguide. In the tube of the microwave waveguide 41, an iris 43 is provided near the connecting portion (e.g., a position separate from the central axis of the feeding waveguide 33A by about ¼ the tube wavelength) to the feeding waveguide 33A. The iris 43 is formed of walls projecting vertically from the left and right side walls of the microwave waveguide 41. When the iris 43 adjusts the width of the tube of the microwave waveguide 41, the impedance between the power supply side and load side of the microwave waveguide 41 can be matched. In other words, the iris 43 serves as an impedance matching unit. The position of the opening 13A is not limited to the central portion of the E-surface 13, but the opening 13A may be formed in, e.g., each of end faces 15C and 16C of the feeding waveguide 33A.

In the tube of the feeding waveguide 33A, guide walls 20 which project vertically from the E-surface 13, where the opening 13A is formed, toward the centers in the widthwise direction of the feeding windows 17A extend between upper and lower H-surfaces 12C and 11C. The projecting length of each guide wall 20 is set to about ⅕ the width (length in the Y-axis direction) of the feeding waveguide 33A. No delay material is arranged in the tube of the feeding waveguide 33A, and accordingly the feeding waveguide 33A is hollow.

Assuming that the tube wavelength of the feeding waveguide 33A is defined as λg₀, the feeding windows 17A are formed substantially at the interval of λg₀. In contrast to this, the width of each of the square waveguides 32A to 32H is substantially λg₀/2. The other end of each of the two square waveguides which are adjacent through one feeding window 17A is set to communicate with the feeding waveguide 33A. Of E-surfaces 18 and 19 of each square waveguide, the E-surface 18 which does not oppose the feeding window 17A is connected to the E-surface 17 of the feeding waveguide 33A, while the feeding window 17A-side leading end of the E-surface 19 which opposes the feeding window 17A is slightly retracted. Thus, the microwaves can be easily introduced from the feeding waveguide 33A into the two adjacent square waveguides through the corresponding feeding windows 17A. Therefore, the length in the Y-axis direction of the E-surface 19 is shorter than the length in the Y-axis direction of the E-surface 18, and may be about, e.g., 1 mm. The E-surface 19 may be formed of a conductive pin extending between upper and lower H-surfaces 12B and 11B.

The microwave distributor 33 is adjusted to supply the microwaves to all of the square waveguides 32A to 32H equally. For example, the larger the widths (lengths in the X-axis direction) of the feeding windows 17A, the larger the microwave supply power. Thus, the farther away from the opening 13A to be connected to the microwave oscillator 42, the larger the widths of the feeding windows 17A. The microwave supply power may be adjusted by changing the positions of the guide walls 20 in the axial direction (X-axis direction) of the feeding waveguide 33A.

According to this embodiment, the parallel-plate waveguide 31A of the parallel-plate antenna 31, the square waveguides 32A to 32H, and the feeding waveguide 33A of the microwave distributor 33 are formed of two flat plates 11 and 12 of the same shape which are square when seen from the top and arranged separate from each other to be substantially parallel to each other, the side wall 13 and side walls 14, 15, and 16 which connect the four sides of the flat plate 11 to the four sides of the flat plate 12, the partition member 17 which is disposed at a position separate from the side wall 13 by substantially λg₀/2 to be parallel to the side walls 13 and 14, and the partition members 18 and 19 which equally divide the region from the partition member 17 to a predetermined distance toward the side wall 14 to be parallel to the side walls 15 and 16. The flat plates 11 and 12, side walls 13 to 16, and partition members 17 to 19 are made of a conductor such as copper. To form the partition members 17 to 19, conductive plates extending between the flat plates 11 and 12 are used. Alternatively, conductive pins which are arranged at such a short interval that the microwaves cannot pass between them can be used instead.

In this case, the parallel-plate waveguide 31A includes the portions 11A and 12A of the flat plates 11 and 12, the side wall 14, and the portions 15A and 16A of the side walls 15 and 16. The square waveguide array 32 includes the portions 11B and 12B of the flat plates 11 and 12, portions 15B and 16B of the side walls 15 and 16, and the partition members 18 and 19. The feeding waveguide 33A includes portions 11C and 12C of the flat plates 11 and 12, the side wall 13, the portions 15C and 16C of the side walls 15 and 16, and the partition member 17. The opening 13A is formed at the central portion of the side wall 13. The plurality of feeding windows 17A are formed in the partition member 17. The plurality of radiation slots 21 are formed in the portion 11A of the flat plate 11.

In the description of the above arrangement, the corresponding members are denoted by the same reference numeral, e.g., the E-surfaces 18 and partition members 18 of the square waveguide.

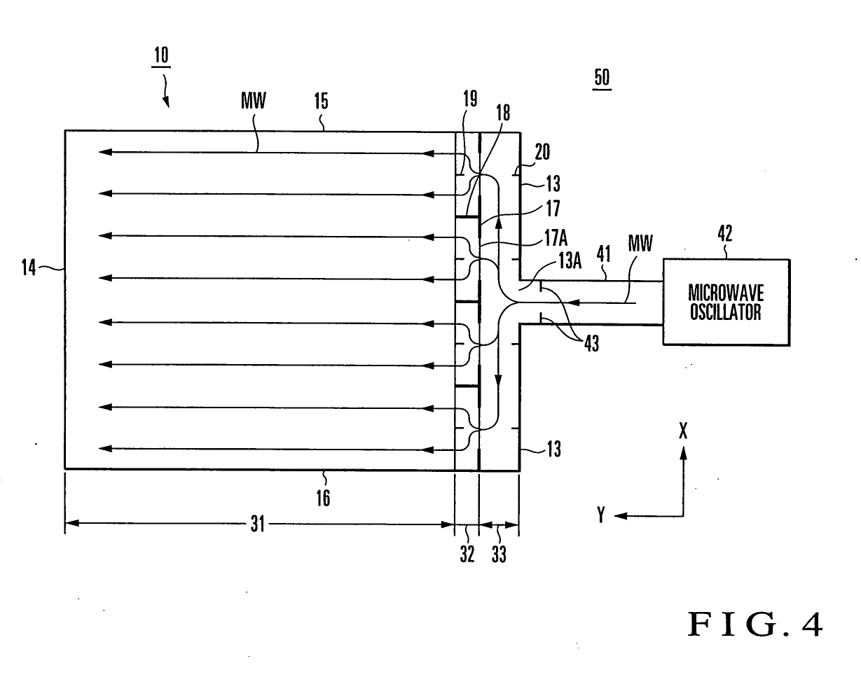

The operation of the plasma processing apparatus according to this embodiment will be described with reference to FIG. 4.

When the microwave oscillator 42 is driven, microwaves MW are introduced from the opening 13A of the microwave distributor 33 into the tube of the feeding waveguide 33A of the microwave distributor 33 through the microwave waveguide 41. The iris 43 is provided in the tube of the microwave waveguide 41 to match the impedance. Thus, reflection of the microwaves MW at the connecting portion of the microwave waveguide 41 and feeding waveguide 33A is suppressed.

The microwaves MW introduced from the central portion into the tube of the feeding waveguide 33A is divided into two branches to propagate toward the two end faces 15C and 16C of the feeding waveguide 33A in the axial direction of the feeding waveguide 33A, that is, in the X-axis direction. The branched microwaves MW are guided to the guide walls 20 disposed at the interval of substantially λg₀ in the X-axis direction and equally distributed to the square waveguides 32A to 32H through the feeding windows 17A which oppose the guide walls 20. As the feeding windows 17A are also arranged at the interval of substantially λg₀ in the X-axis direction, the microwaves MW are distributed to the square waveguides 32A to 32H with the same phase.

The microwaves MW distributed to the square waveguides 32A to 32H are introduced to the parallel-plate waveguide 31A with the same phase directly. The microwaves MW introduced to the parallel-plate waveguide 31A propagate in the waveguide where the delay member 22 is arranged in the axial directions of the square waveguides 32A to 32H, i.e., in the Y-axis direction. The microwaves MW are then gradually radiated from the plurality of radiation slots 21 formed in one conductive plate 11A which forms the parallel-plate waveguide 31A, and transmitted through the dielectric plate 8 to be supplied into the processing vessel 1. The microwaves MW which are not radiated from the radiation slots 21 but left are absorbed by the microwave absorbing member 23.

The electric field of the microwaves MW supplied into the processing vessel 1 accelerates the electrons to ionize, excite, and dissociate the gas in the processing vessel 1, thus generating a reaction-active species. The reaction-active species processes the surface of the LCD substrate 3 on the stage 2 by, e.g., etching, ashing, or CVD.

The plasma processing apparatus according to this embodiment uses, in place of the conventional waveguide slot antenna array 970, the antenna unit 10 as a combination of the parallel-plate antenna 31 and square waveguide array 32. The same operation and effect as those of the prior art can be obtained, as described above.

In addition, since the delay member 22 is arranged in the parallel-plate waveguide 31A of the parallel-plate antenna 31, the tube wavelength of the parallel-plate waveguide 31A decreases, and the interval of the radiation slots 21 which is set on the basis of the tube wavelength also decreases. When compared to a case wherein the delay member 22 is not arranged, the microwaves can be supplied into the processing vessel 1 at a short interval, so that the plasma density distribution can be uniformed.

The interior of the parallel-plate waveguide 31A does not have a partition like that in the conventionally used waveguide slot antenna array 970. Only, one delay member 22 may be sufficient to arrange in the parallel-plate waveguide 31A. The number of delay members 22 to be used becomes smaller than that of the prior art, so that an increase in manufacturing cost of the plasma processing apparatus which occurs when the plasma density distribution is formed can be suppressed.

As the inclination 22A is formed on that end of the delay member 22 where the feeding windows 17A are present, a change in dielectric constant from air at the boundary of the square waveguides 32A to 32H and the parallel-plate waveguide 31A to the dielectric becomes moderate to decrease reflection of the microwaves at this boundary. As a result, the microwaves can be supplied to the parallel-plate waveguide 31A efficiently.

This embodiment employs the microwave distributor 33 in which the plurality of feeding windows 17A are formed in the E-surface of the feeding waveguide 33A extending in a direction in which the square waveguides 32A to 32H are aligned. With this microwave distributor 33, the length of the parallel-plate waveguide 31A in the X-axis direction is increased to increase the open area of the slot antenna. Even when the number of square waveguides which form the square waveguide array 32 increases, the feeding waveguide 33A having the same length as the sum of the widths of all the square waveguides may be used. Thus, the apparatus arrangement will not become so much complicated and bulky as in the conventional microwave distributor 980. When the number of square waveguides is other than 2ⁿ, it can be coped with only by adjusting the length of the feeding waveguide 33A. Hence, the apparatus arrangement can be suppressed from becoming complicated and bulky when the open area of the slot antenna is to be increased, and the degrees of freedom in design of the apparatus arrangement can be increased. If these effects are not necessary, a microwave distributor having another arrangement, e.g., the conventional microwave distributor 980, may be used.

The iris 43 is disposed in the tube of the microwave waveguide 41 to match the impedance between the power supply side and load side of the microwave waveguide 41. Thus, reflection of the microwaves at the connecting portion of the microwave waveguide 41 and the feeding waveguide 33A of the microwave distributor 33 is suppressed, so that the microwaves can be introduced into the feeding waveguide 33A efficiently.

The guide walls 20 are disposed in the tube of the feeding waveguide 33A of the microwave distributor 33 to guide the microwaves propagating in the feeding waveguide 33A to the square waveguides 32A to 32H through the feeding windows 17A. Thus, the microwaves can be efficiently supplied from the feeding waveguide 33A to the square waveguides 32A to 32H the axial directions of which are perpendicular to the feeding waveguide 33A.

No delay member is arranged in the tube of the feeding waveguide 33A of the microwave distributor 33. As the tube of the feeding waveguide 33A of the microwave distributor 33 is left hollow, the diameter of the feeding waveguide 33A need not be decreased to decrease the supply power. Accordingly, the number of square waveguides to which the feeding waveguide 33A can distribute the microwaves does not change, and the degrees of freedom in design of the apparatus arrangement are not limited.

In the parallel-plate antenna 31, the radiation slots 21 may be arranged thick in a direction (X-axis direction) perpendicular to the traveling direction of the microwaves in the parallel-plate waveguide 31A to such a degree that the adjacent radiation slots 21 do not overlap. Thus, when the parallel-plate antenna 31 is used, a larger number of radiation slots 21 can be arranged in the same area than in the waveguide slot antenna array 970, so that large power can be supplied into the processing vessel 1.

The inverted-V shaped slots are formed as the radiation slots 21 to radiate circularly polarized waves into the processing vessel 1. The electric field rotates in a plane parallel to the conductive plate 11A having the radiation slots 21. Thus, a plasma which is uniform when seen as a time-base average is generated in this plane. When the LCD substrate 3 is arranged parallel to the conductive plate 11A which has the radiation slots 21, the surface of the LCD substrate 3 can be processed uniformly.

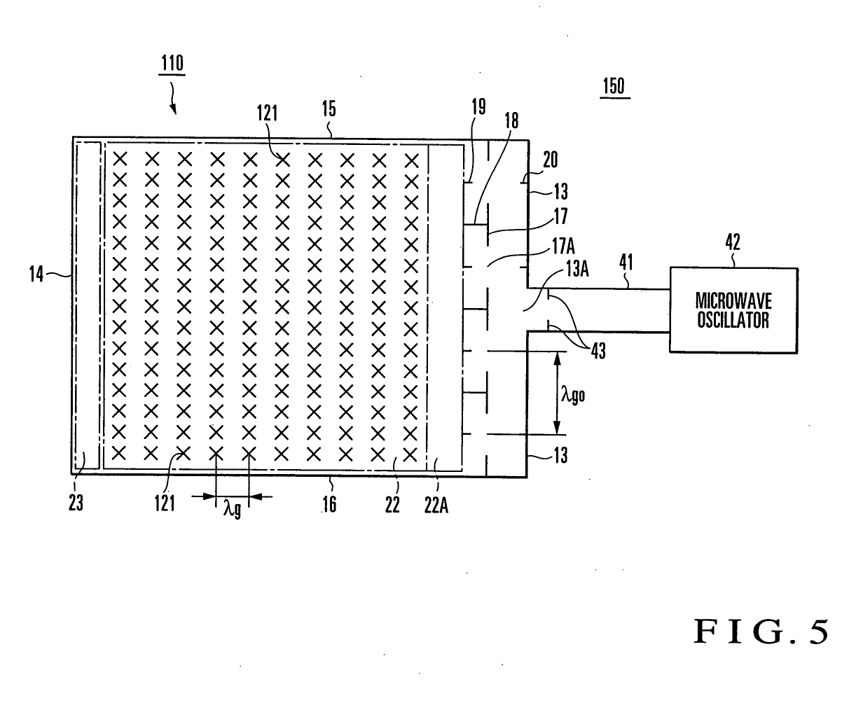

As in a microwave supply device 150 shown in FIG. 5, cross slots may be used as radiation slots 121 which radiate circularly polarized waves. In each cross slot, two slots which form a pair intersect at their centers. The cross slot is arranged such that the electric fields radiated from the respective slots have the same magnitude and are phase-shifted from each other by 90°, and that their polarizing directions are orthogonal. For example, when the specific dielectric constant εr in the parallel-plate waveguide 31A is 3.6, the two slots are set to have lengths of 2.94 cm and 3.19 cm, respectively. The two slots are arranged such that they cross each other at a substantially right angle and that they are inclined with respect to the Y-axis by substantially 45°. Alternatively, two slots may be set to have lengths of 2.80 cm and 3.83 cm, respectively. The two slots may be arranged such that they cross each other at an angle of substantially 107° and that they are inclined with respect to the Y-axis by substantially 36.5°.

According to this embodiment, the opening 13A and feeding windows 17A are formed in the E-surfaces 13 and 17 of the feeding waveguide 33A of the microwave distributor 33. Alternatively, a microwave distributor may be used in which an opening and feeding windows are formed in the H-surfaces of the feeding waveguide 33A. In this case, the E- and H-surfaces of the waveguides which form the square waveguide array are also reversed.

According to this embodiment, the square waveguide array 32 includes the eight square waveguides 32A to 32H. The square waveguide array suffices as far as it includes two or more square waveguides.

These modifications can naturally be applied to the following embodiments as well.

### Second Embodiment

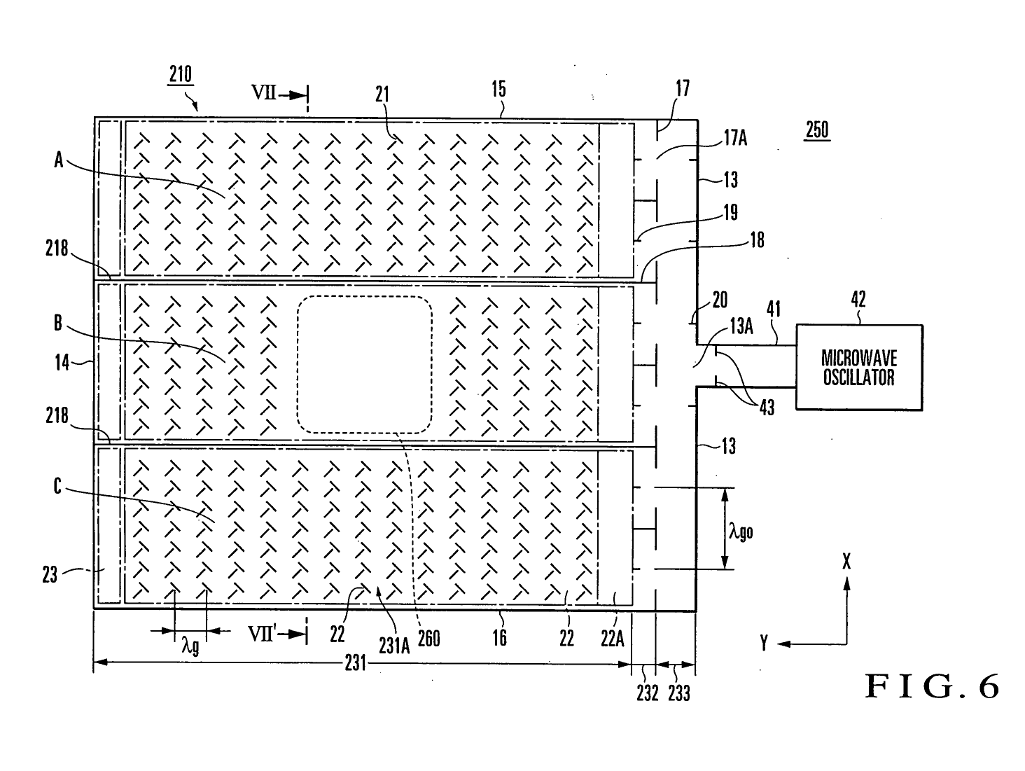

A plasma processing apparatus according to the second embodiment of the present invention uses a microwave supply device in which the microwave supply power has a distribution within a surface where the slots of a parallel-plate antenna are formed. This microwave supply device will be described with reference to FIG. 6. In FIG. 6, the constituent elements which correspond to those shown in FIG. 2 are denoted by the same reference numerals as in FIG. 2.

In a microwave supply device 250 shown in FIG. 6, the interior of a parallel-plate waveguide 231A of a parallel-plate antenna 231 is divided into three regions A, B, and C by two partition members 218. The width (length in the X-axis direction) of each of the regions A to C is N times (N is an integer larger than 2) the width of each of square waveguides 32A to 32H. In this embodiment, N=4.

The partition members 218 are connected to E-surfaces 18 of a square waveguide which are perpendicular to first and second conductive plates 11A and 11B which form the parallel-plate waveguide 231A, and extend parallel to side walls 15 and 16 from the openings of the parallel-plate waveguide 231A to a side wall 14 which opposes the openings, and between the first and second conductive plates 11A and 11B. As the partition members 218, conductive plates extending between flat plates 11 and 12 are used. Alternatively, conductive pins which are arranged at such a short interval that the microwaves cannot pass between them can be used instead.

When the above structure is paraphrased, the E-surfaces 18 of the square waveguide extend parallel to the side walls 15 and 16 until the side wall 14 of the parallel-plate waveguide 231A.

In the parallel-plate antenna 231, the positions and number of radiation slots 21 differ according to the positions of the regions A to C of the parallel-plate waveguide 231A. More specifically, no radiation slots 21 are arranged at a central portion 260 of the region B which is located in the middle of the parallel-plate waveguide 231A. Consequently, the radiation slots 21 are arranged only at the regions excluding the central portion 260 of the first conductive plate 11A. The shape of the central portion 260 where no radiation slots 21 are arranged may be square or circular.

When the plasma in a processing vessel 1 reaches a steady state, the distribution of the plasma density tends to increase in the space above the central portion of a stage 2. If no radiation slots 21 are arranged at the portion 260 which opposes the central portion of the stage 2, the microwaves are not radiated to the space above the central portion of the stage 2 where the plasma density is high, and accordingly plasma generation in this space is suppressed. As a result, the distribution of the plasma density can be uniformed.

A square waveguide array 232 includes 12 square waveguides. The 12 square waveguides are divided into three sets (each including four square waveguides), and the respective sets communicate with the corresponding ones of the regions A, B, or C of the parallel-plate waveguide 231A.

A microwave distributor 233 adjusts the microwave supply power for each of the square waveguide sets communicating with the corresponding ones of the regions A, B, and C of the parallel-plate waveguide 231A. More specifically, in the square waveguides which communicate with the region B having the central portion 260 where no radiation slots 21 are arranged, the microwave supply power is set to be smaller than in the square waveguides which communicate with the regions A and C. The microwave supply power can be adjusted by the widths of feeding windows 17A or the positions of guide walls 20.

When the microwave supply power is adjusted in this manner, in the region B of the parallel-plate waveguide 231A, the microwaves that are not radiated from the radiation slots 21 but to be finally absorbed by a microwave absorbing member 23 are decreased, so that power loss can be decreased.

Even if the microwave supply powers are different among the regions A to C of the parallel-plate waveguide 231A, as the regions A to C are completely divided by the partition members 218, the microwaves propagating in the respective regions will not adversely affect the adjacent regions.

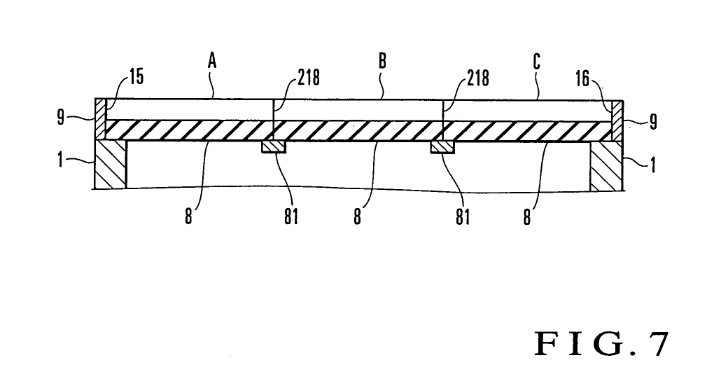

When the area of a dielectric plate 8 is to be increased to match a large-size antenna, the dielectric plate 8 must be reinforced to be able to stand the high vacuum in the processing vessel 1. To reinforce the dielectric plate 8, a beam may be extended as a reinforcing member under the dielectric plate 8 (inside the processing vessel 1) to support the dielectric plate 8 from below. In this embodiment, no microwaves are radiated from near the partition members 218 which divide the interior of the parallel-plate waveguide 231A. Hence, as shown in FIG. 7, when beams (reinforcing members) 81 are extended to oppose the partition members 218, the influence of the beams 81 on the microwaves can be decreased.

### Third Embodiment

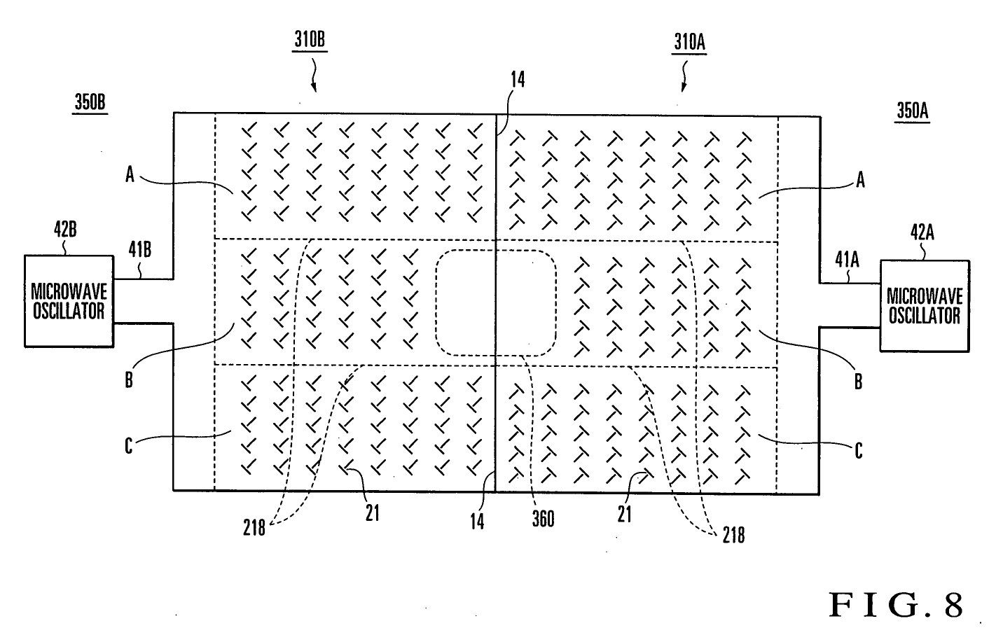

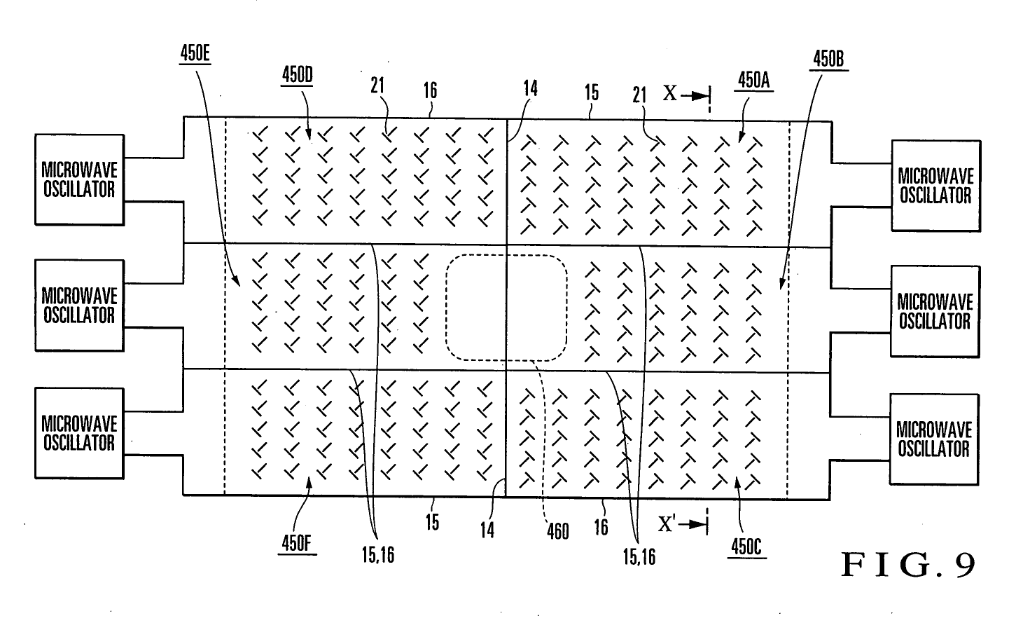

A plasma processing apparatus according to the third embodiment of the present invention uses a plurality of microwave supply devices in combination. This plasma processing apparatus will be described with reference to FIGS. 8 and 9. In FIGS. 8 and 9, the constituent elements corresponding to those shown in FIG. 2 or 6 are denoted by the same reference numerals as in FIG. 2 or 6.

The arrangement shown in FIG. 8 uses two microwave supply devices 350A and 350B respectively having parallel-plate antennas 310A and 310B. In each of the parallel-plate antennas 310A and 310B, the interior of a parallel-plate waveguide 231A is divided into a plurality of regions by partition members 218, in the same manner as in the microwave supply device 250 shown in FIG. 6. The two microwave supply devices 350A and 350B are arranged such that side walls 14 as the terminal ends of the respective parallel-plate waveguides 231A oppose, so respective first conductive plates 11A of the parallel-plate antennas 310A and 310B are continuous on one plane.

When the two microwave supply devices 350A and 350B are used in combination in this manner, power supply to a processing vessel 1 can be shared by two microwave oscillators 42A and 42B. For example, when power of 10 kW is to be supplied to the processing vessel 1, two microwave oscillators each having output power of 5 kW may be used. Even when large power must be applied to the processing vessel 1 as in a case wherein a plasma process is to be performed using a large-diameter processing vessel 1, if a plurality of low-output, inexpensive microwave oscillators are used, the manufacturing cost of the entire plasma processing apparatus can be decreased.

In the arrangement shown in FIG. 8, radiation slots 21 are not arranged at a central portion 360 of a surface which is formed of the respective first conductive plates 11A of the parallel-plate antennas 310A and 310B, but only on a region excluding the central portion 360. The portion 360 where no radiation slots 21 are arranged opposes the central portion of the stage 2.

More specifically, of the respective parallel-plate waveguides 231A of the parallel-plate antennas 310A and 310B, the radiation slots 21 are arranged in the entire regions A and C, whereas the radiation slots 21 are arranged in the regions B only at portions excluding portions close to the side walls 14 which are the terminal ends.

When the radiation slots 21 are arranged in this manner, plasma generation in a space above the central portion of the stage 2 having a high plasma density is suppressed, in the same manner as in the second embodiment. As a result, the distribution of the plasma density can be uniformed.

The arrangement shown in FIG. 9 uses six microwave supply devices 450A, 450B, 450C, 450D, 450E, and 450F respectively having parallel-plate antennas. In each parallel-plate antenna, the interior of a parallel-plate waveguide 31A is not divided, in the same manner as the microwave supply device 50 shown in FIGS. 1 to 3.

The microwave supply devices 450A, 450B, and 450C are arranged such that adjacent side walls 15 and 16 of the respective parallel-plate antennas oppose each other. The same applies to the microwave supply devices 450D, 450E, and 450F. The microwave supply devices 450A and 450D are arranged such that their side walls 14 serving as the terminal ends of the respective parallel-plate antenna oppose each other. This applies to the microwave supply devices 450B and 450E, and 450C and 450F. Hence, the first conductive plates 11A of the parallel-plate antennas where the radiation slots 21 are arranged can be made continuous on one plane.

When the more microwave supply devices 450A to 450F than in the arrangement shown in FIG. 8 are used in combination, lower-output, less-expensive microwave oscillators can be used to further decrease the manufacturing cost of the entire plasma processing apparatus.

In the arrangement shown in FIG. 9, radiation slots 21 are not arranged at a central portion 460 of a surface which is formed of the first conductive plates 11A of the parallel-plate antennas of the microwave supply devices 450A to 450F, but only on a region excluding the central portion 460. The portion 460 where no radiation slots 21 are arranged opposes the central portion of the stage 2.

More specifically, of the microwave supply devices 450A, 450C, 450D, and 450F, the radiation slots 21 are arranged in the entire respective first conductive plates 11A, whereas the radiation slots 21 are arranged in conductive plates 11A of the microwave supply devices 450B and 450E only at portions excluding portions close to the side walls 14.

When the radiation slots 21 are arranged in this manner, plasma generation in a space above the central portion of the stage 2 having a high plasma density is suppressed, in the same manner as in the second embodiment. As a result, the distribution of the plasma density can be uniformed.

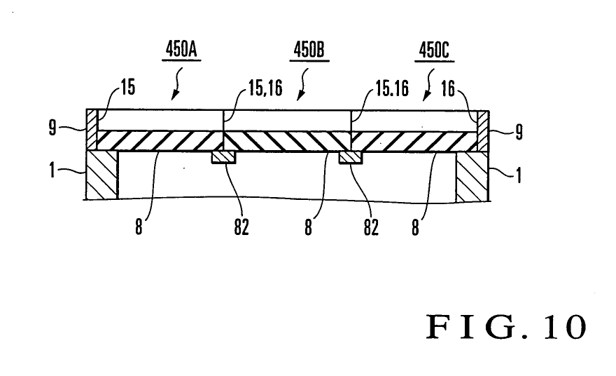

According to this embodiment, in the microwave supply devices 450A to 450F, microwaves are not radiated from near the side walls 14 to 16 which form the boundaries of the plurality of adjacent parallel-plate antennas. When a beam is to be extended as a reinforcing member under the dielectric plate 8 (inside the processing vessel 1) to support the dielectric plate 8 from below, beams (reinforcing members) 82 are extended to oppose the boundaries of the plurality of parallel-plate antennas described above, as shown in FIG. 10. Thus, the influence of the beams 82 on the microwaves can be decreased.

Although the various embodiments of the present invention have been described, combinations of the technical ideas included in the embodiments described above are also incorporated in the present invention.

The plasma processing apparatus according to the present invention can be used in, e.g., an etching apparatus, ashing apparatus, and CVD apparatus. The plasma processing method according to the present invention can be used in the processes such as etching, ashing, and CVD. Furthermore, the plasma processing apparatus and method can also be used in the manufacture of a flat panel display such as an LCD.

What is claimed is:

1. A plasma processing apparatus comprising:
a stage which places a target object thereon;
a processing vessel which accommodates said stage; and
a microwave supply device which supplies microwaves into said processing vessel,
said microwave supply device including
a parallel-plate waveguide including a first conductive plate which is rectangular when seen from the top and arranged to oppose said stage and a second conductive plate which is arranged substantially parallel to said first conductive plate and has the same shape as that of said first conductive plate when seen from the top,
a plurality of slots formed in said first conductive plate,
a square waveguide array which includes a plurality of square waveguides aligned in widthwise directions (X) thereof perpendicular to axial directions (Y) thereof and in which one end of each of said square waveguides is connected to said parallel-plate waveguide, and
a distributor which is connected to the other end of each of said square waveguides and distributes and supplies the microwaves to said square waveguides with the same phase.

2. An apparatus according to claim 1, wherein said distributor includes
a feeding waveguide which extends in the widthwise directions of said square waveguides, and
feeding windows which open to a wall surface of said feeding waveguide and through which said feeding waveguide and square waveguides communicate.

3. An apparatus according to claim 2, wherein
each of said square waveguides has a width corresponding to substantially ½ a tube wavelength of said feeding waveguide, and
said feeding windows are disposed at an interval substantially equal to the tube wavelength of said feeding waveguide and through which two adjacent ones of said square waveguides communicate with said feeding waveguide.

4. An apparatus according to claim 2, wherein said distributor further includes a guide wall which projects from a wall surface of said feeding waveguide which opposes said feeding windows toward said feeding windows and guides the microwaves propagating in said feeding waveguide to said square waveguides.

5. An apparatus according to claim 1, wherein said microwave supply device further includes a delay member which is arranged only in said parallel-plate waveguide and made of a dielectric.

6. An apparatus according to claim 5, wherein said delay member includes an inclination at an end thereof which opposes one end of each of said square waveguides.

7. An apparatus according to claim 1, wherein
said parallel-plate waveguide includes a partition member which extends between said first and second conductive plates and from a side of said square waveguides to a side opposing said square waveguides, and
said partition member is connected to, of wall surfaces of said square waveguides, a wall surface perpendicular to one of said first and second conducive plates and made of a conductor.

8. An apparatus according to claim 7, wherein said partition member divides said parallel-plate waveguide to have a width corresponding to N times (N is an integer of not less than 2) a width of each of said square waveguides.

9. An apparatus according to claim 7, wherein positions and a number of said slots change depending on positions of regions obtained by dividing said parallel-plate waveguide by said partition member.

10. An apparatus according to claim 9, wherein said slots are formed only in a region excluding a central portion (260) of said first conductive plate.

11. An apparatus according to claim 9, wherein said distributor supplies, to each of said regions obtained by dividing said parallel-plate waveguide by said partition member, power corresponding to the number of slots formed in said region.

12. An apparatus according to claim 7, wherein
said parallel-plate waveguide is arranged outside said processing vessel, and includes
a dielectric plate which closes an end of said processing vessel on a parallel-plate waveguide side, and
a reinforcing member which extends to oppose said partition member and supports said dielectric plate.

13. An apparatus according to claim 1, wherein said microwave supply device further includes
a microwave oscillator which outputs microwaves,
a microwave waveguide which guides the microwaves output from said microwave oscillator to said distributor, and
an impedance matching unit which is provided to said microwave waveguide and matches impedance between a power supply side and load side.

14. An apparatus according to claim 13, wherein said impedance matching unit is provided to near a connecting portion of said distributor and microwave waveguide and includes an iris which narrows a pipe channel of said microwave waveguide.

15. An apparatus according to claim 1, wherein
said microwave supply device includes a microwave oscillator which supplies microwaves to said distributor,
said microwave supply device includes a plurality of microwave supply devices, and
first conductive plates of said microwave supply devices are arranged on one plane.

16. An apparatus according to claim 15, wherein said slots are formed only in a region excluding a central portion (360) of a surface formed of said first conductive plates of all of said microwave supply device.

17. An apparatus according to claim 15, wherein
said plurality of parallel-plate waveguides are arranged outside said processing vessel, and include
a dielectric plate which closes an end of said processing vessel on a parallel-plate waveguide side, and
a reinforcing member which extends to oppose boundaries of a plurality of parallel-plate waveguides and supports said dielectric plate.

18. An apparatus according to claim 1, wherein said microwave supply device supplies circularly polarized waves into said processing vessel through said slots.

19. A plasma processing method comprising the steps of:
supplying in-phase microwaves to a plurality of square waveguides which form a square waveguide array:
introducing the microwaves transmitted through the square waveguides to a parallel-plate waveguide having a plurality of slots;
supplying the microwaves propagating in the parallel-plate waveguide into the processing vessel through the slots;
generating a plasma using the microwaves supplied into the processing vessel; and
processing a target object on a stage accommodated in the processing vessel using the generated plasma.

20. A flat panel display manufacturing method comprising the steps of:
supplying in-phase microwaves to a plurality of square waveguides which form a square waveguide array:
introducing the microwaves transmitted through the square waveguides to a parallel-plate waveguide having a plurality of slots;
supplying the microwaves propagating in the parallel-plate waveguide into the processing vessel through the slots;
generating a plasma using the microwaves supplied into the processing vessel; and
processing a target object on a stage accommodated in the processing vessel using the generated plasma in accordance with any one of etching, ashing, and CVD.
